(19) United States
(12) Patent Application Publication
(10) Pub. No.: US 2017/0025014 A1
(43) Pub. Date: Jan. 26, 2017

(54) DRIVING ASSISTANT METHOD, SYSTEM, AND VEHICLE

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 14/808,528

(22) Filed: Jul. 24, 2015

(51) Int. Cl. G08G 1/16; H04N 7/18; G01C 3/00; B60Q 9/00

(52) U.S. Cl. CPC G08G 1/166; B60Q 9/008; H04N 7/183; G01C 3/00

(57) ABSTRACT

In a driving assistance method executed in a vehicle, at least one image behind the vehicle is captured. A distance between the vehicle and an object presented in the image is calculated according to the image. If the object is within a predefined safe distance from the vehicle, an alarm is generated that is outside the vehicle and directed at the object.

### FIELD

The subject matter herein generally relates to transportation safety.

### BACKGROUND

A vehicle may be rear-ended if the following vehicle is too close. Therefore, there is a need for a vehicle to safely monitor a distance of following vehicles.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a driving assistant system.

FIG. 2 is a block diagram of one example embodiment of function modules of the driving assistant system in FIG. 1.

FIG. 3 is a flowchart of one example embodiment of a driving assistant method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

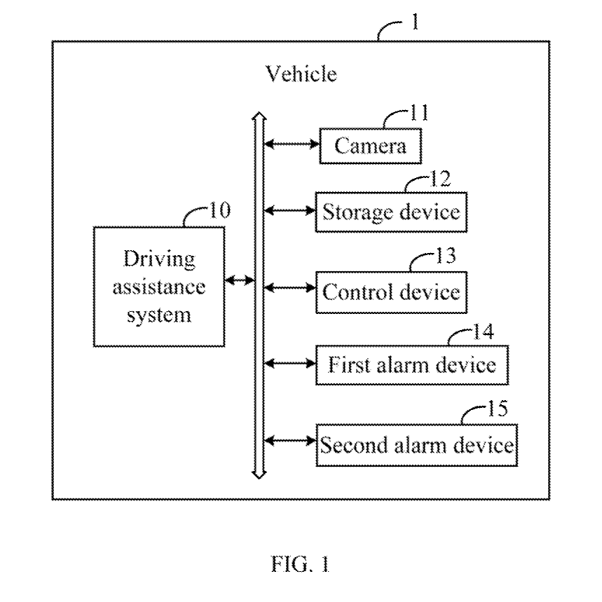

FIG. 1 is a block diagram of one example embodiment of a hardware environment for executing a driving assistant system 10. The driving assistant system 10 is installed in and run by a vehicle 1. The vehicle 1 can be a car, a truck, a bus, or a train, for example. The vehicle 1 can further include at least one camera 11, a storage device 12, at least one control device 13, a first alarm device 14, and a second alarm device 15. The camera 11 and the first alarm device 14 can be installed in a tail section of the vehicle 1. The first alarm device 14 can include a first warning lamp and/or a first audio device. The second alarm device 15 can be installed inside the vehicle 1. For example, the second alarm device 15 includes a second warning lamp and/or a second audio device. The second warning lamp and/or a second audio device are installed on a dashboard of the vehicle 1.

The camera 11 captures at least one image behind the vehicle 1. In this embodiment, the camera 11 can be a depth-sensing camera, such as a time of flight (TOF) camera. The image captured by the camera 11 includes distance information indicating a distance between a lens of the camera 11 and each point on an object presented in the image. The object can be another vehicle, for example.

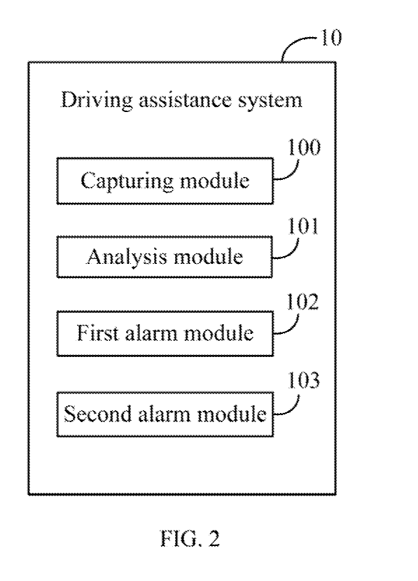

The driving assistant system 10 can include a plurality of function modules (shown in FIG. 2) that detect a distance between the vehicle 1 and the object according to the images captured by the camera 11, and send out alarms when the object is too close to the vehicle 1.

The storage device 12 can include some type(s) of non-transitory computer-readable storage medium such as, for example, a hard disk drive, a compact disc, a digital video disc, or a tape drive. The storage device 12 stores images captured by the camera 12. The storage device 12 further stores the computerized codes of the function modules of the driving assistant system 10.

The control device 13 can be a processor, a microprocessor, an application-specific integrated circuit (ASIC), or a field programmable gate array (FPGA), for example. The control device 13 can execute computerized codes of the function modules of the driving assistant system 10 to realize the functions of the vehicle 1.

FIG. 2 is a block diagram of one embodiment of function modules of the driving assistant system 10. The function modules can include, but are not limited to, a capturing module 100, an analysis module 101, a first alarm module 102, and a second alarm module 103. The function modules 100-103 can include computerized codes in the form of one or more programs, which provide at least the functions of the driving assistant system 10.

The capturing module 100 is configured to control the camera 11 to capture at least one image behind the vehicle 1. The capturing module 100 can determine whether the vehicle 1 is moving forward. If the vehicle 1 is moving forward, the capturing module 100 controls the camera 11 to capture the image behind the vehicle 1. In this embodiment, the image includes distance information between the lens of the camera 11 and each point on an object in the image.

The analysis module 101 is configured to analyze a distance between the vehicle 1 and the object according to the image, and determine whether the distance is less than a predefined safe distance (e.g., 4 meters). The analysis module 101 can calculate distances from the lens of the camera 11 to points on the object in the image according to the distance information, and determine a shortest distance from the lens of the camera 11 to the points on the object. The shortest distance is regarded as the distance between the vehicle 1 and the object. The safe distance can be preset according to a speed of the vehicle 1. For example, the higher the speed of the vehicle 1, the longer the safe distance that is set.

The first alarm module 102 is configured to generate a first alarm via the first alarm device 14 to alert the object to keep the safe distance from the vehicle 1. In at least one embodiment, when the distance is less than the safe distance, the first warning module 102 controls the first warning lamp to flash or controls the first audio device to generate a first alarm sound, to alert the object to keep the safe distance from the vehicle 1.

The second alarm module 103 is configured to generate a second alarm via the second alarm device 15 to alert a driver of the vehicle 1 that the object is within the predefined safe distance. In at least one embodiment, when the distance is less than the safe distance, the second warning module 103 controls the second warning lamp installed on the dashboard of the vehicle 1 to flash or controls the second audio device inside the vehicle 1 to generate a second alarm sound, to alert the driver that the object is within the predefined safe distance.

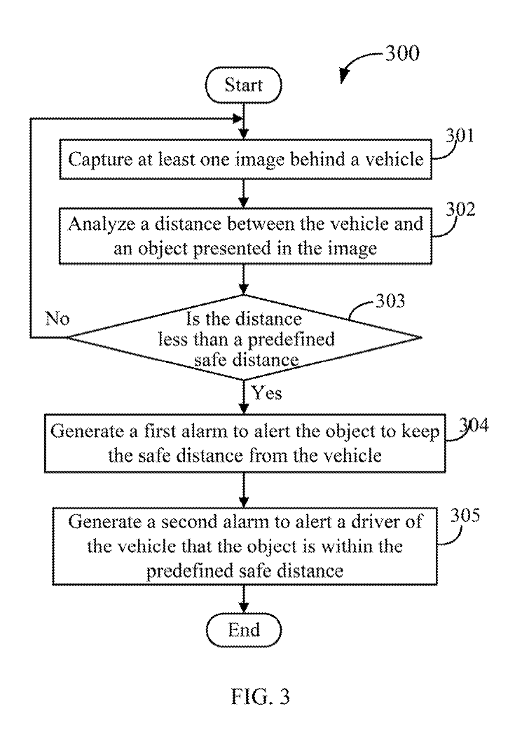

FIG. 3 is a flowchart of one example embodiment of a driving assistance method. In the embodiment, the method is performed by execution of computer-readable software program codes or instructions by a control device, such as at least one processor of a vehicle. The vehicle can further include at least one camera, a storage device, a first alarm device, and a second alarm device. The camera and the first alarm device can be installed in a tail section of the vehicle. The first alarm device can include a first warning lamp and/or a first audio device. The second alarm device can be installed inside the vehicle. For example, the second alarm device includes a second warning lamp and/or a second audio device. The second warning lamp and/or a second audio device are installed on a dashboard of the vehicle.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, a capturing module controls the camera to capture at least one image behind the vehicle. The capturing module can determine whether the vehicle is moving forward. If the vehicle is moving forward, the capturing module controls the camera to capture the image behind the vehicle. In at least one embodiment, the camera is a depth-sensing camera. Each image captured by the camera includes distance information between a lens of the camera and objects presented in the image.

At block 302, an analysis module analyzes a distance between the vehicle and an object presented in the image according to the image. The object can be another vehicle, for example. The analysis module can calculate distances from the lens of the camera to points on the object in the image according to the distance information, and determine a shortest distance from the lens of the camera to points on the object. The shortest distance is regarded as the distance between the vehicle and the object.

At block 303, the analysis module determines whether the distance is less than a predefined safe distance (e.g., 4 meters). If the distance is not less than the predefined safe distance, the process returns to block 301. The safe distance can be preset according to a speed of the vehicle. For example, the higher the speed of the vehicle, the longer the safe distance that is set.

If the distance is less than the predefined safe distance, at block 304, a first alarm module generates a first alarm via the first alarm device to alert the object to keep the safe distance from the vehicle. In at least one embodiment, when the distance is less than the safe distance, the first warning module controls the first warning lamp to flash or controls the first audio device to generate a first alarm sound, to alert the object to keep the safe distance from the vehicle.

At block 305, a second alarm module generates a second alarm via the second alarm device to alert a driver of the vehicle that the object is within the predefined safe distance. In at least one embodiment, when the distance is less than the safe distance, the second warning module controls the second warning lamp on the dashboard of the vehicle to flash or controls the second audio device inside the vehicle to generate a second alarm sound, to alert the driver that the object is within the predefined safe distance.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A driving assistance method comprising:
controlling, at a processor, a camera installed on a vehicle to capture an image behind the vehicle;
analyzing, at the processor, a distance between the vehicle and an object presented in the image; and
generating, at the processor, an alarm if the object is within a predefined safe distance from the vehicle, wherein the alarm is outside the vehicle and directed at the object.

2. The method according to claim 1, further comprising:
generating, at the processor, a second alarm to alert a driver of the vehicle that the object is within the predefined safe distance.

3. The method according to claim 1, wherein the camera is a depth-sensing camera, and captures distance information between a lens of the camera and points on the object in the image.

4. The method according to claim 3, further comprising:
calculating distances from the lens of the camera to the points on the object in the image according to the distance information;
determining a shortest distance from the lens of the camera to the points on the object.

5. A vehicle comprising:
a control device; and
a storage device storing one or more programs which when executed by the control device, causes the control device to perform operations comprising:
controlling a camera installed on the vehicle to capture an image behind the vehicle;
analyzing a distance between the vehicle and an object presented in the image; and
generating an alarm if the object is within a predefined safe distance from the vehicle, wherein the alarm is outside the vehicle and directed at the object.

6. The vehicle according to claim 5, wherein the operations further comprise:
generating a second alarm to alert a driver of the vehicle that the object is within the predefined safe distance.

7. The vehicle according to claim 5, wherein the camera is a depth-sensing camera, and captures distance information between a lens of the camera and points on the object in the image.

8. The vehicle according to claim 7, wherein the operations further comprise:
calculating distances from the lens of the camera to the points on the object in the image according to the distance information;
determining a shortest distance from the lens of the camera to the points on the object in the image.

9. A non-transitory storage medium having stored thereon instructions that, when executed by a control device of a vehicle, causes the control device to perform a driving assistance method, the method comprising:
controlling a camera installed on the vehicle to capture an image behind the vehicle;
analyzing a distance between the vehicle and an object presented in the image; and
generating an alarm if the object is within a predefined safe distance from the vehicle, wherein the alarm is outside the vehicle and directed at the object.

10. The non-transitory storage medium according to claim 9, wherein the method further comprises:
generating a second alarm to alert a driver of the vehicle that the object is within the predefined safe distance.

11. The non-transitory storage medium according to claim 9, wherein the camera is a depth-sensing camera, and captures distance information between a lens of the camera and points on the object in the image.

12. The non-transitory storage medium according to claim 11, wherein the method further comprises:
calculating distances from the lens of the camera to the points on the object in the image according to the distance information;
determining a shortest distance from the lens of the camera to the points on the object.
